(19) United States
(12) Patent Application Publication
(10) Pub. No.: US 2026/0240077 A1
(43) Pub. Date: Aug. 20, 2026

(54) RATOON CUT QUALITY MONITORING SYSTEM

(71) Applicant: Deere & Company, Moline, IL (US)

(72) Inventors: Ankur Satpute, Pune (IN); Rohan Rangari, Pune (IN); Prashant Koparde, Pune (IN); Rishish Kumar Naik, Pune (IN); Maitreyee Milind Tambe, Pune (IN); Karthik Durgavajjala, Pune (IN); Rasika Wagh, Pune (IN)

(21) Appl. No.: 19/057,314

(22) Filed: Feb. 19, 2025

(51) Int. Cl. A01D 45/10; A01D 34/00

(52) U.S. Cl. CPC A01D 45/10; A01D 34/006

(57) ABSTRACT

A sugarcane harvester including a knockdown roller having an adjustable height and a base cutter positioned to sever sugarcane plants from the ground. The base cutter has an adjustable speed and angle. One or more vibration sensors are mounted to the base cutter to detect vibration resulting from severing the sugarcane plants and configured to generate one or more vibration signals. A controller is in communication with the one or more vibration sensors. The controller being configured to: receive the one or more vibration signals, assess ratoon cut quality based on the one or more vibration signals, and execute a corresponding response strategy.

### FIELD OF THE DISCLOSURE

The present disclosure relates to a sugarcane harvester and more particularly to a sugar cane ratoon cut quality monitoring system.

### BACKGROUND

A sugarcane harvester severs sugarcane plants from the ground with a base cutter assembly and transports the severed plants to a set of chopping drums that chop the severed plant into smaller billets. The billets are sent through a cleaning arrangement to separate the billets from non-billet material such as leaves, dirt, and other trash. Passing through the cleaning system, the billets are then discharged, for example, to be transported or stowed in a trailing vehicle. Sugarcane production uses the ratooning method where the roots and a small portion of crop above the ground, called a “ratoon,” is left intact after harvesting. The ratoon is then allowed to regrow, and the crop is again harvested.

### SUMMARY

In one implementation of the present disclosure, a sugarcane harvester includes a knockdown roller having an adjustable height and a base cutter positioned to sever sugarcane plants from the ground. The base cutter has an adjustable speed and angle. One or more vibration sensors are mounted to the base cutter to detect vibration resulting from severing the sugarcane plants and configured to generate one or more vibration signals. A controller is in communication with the one or more vibration sensors. The controller being configured to: receive the one or more vibration signals, assess ratoon cut quality based on the one or more vibration signals, and execute a corresponding response strategy.

In one example of this implementation, the one or more vibration signals includes one or more impacts each having a duration and amplitude corresponding to a blade severing a sugarcane plant from the ground. In a second example, the duration exceeding a duration threshold corresponds to a low ratoon cut quality. In a third example, the amplitude falling below an amplitude threshold corresponds to a low ratoon cut quality. In a fourth example, the controller is configured to keep track of impacts that indicate a low ratoon cut quality and execute the response strategy when the number of low-quality ratoon cuts exceeds a threshold. In a fifth example, the response strategy includes changing one or more of the knockdown roller height, the base cutter speed, the base cutter angle, or a harvester speed.

In another example, the controller is configured to assess the one or more vibration signals with a model. In a further example, the model is a trained neural network. In still another example, the model is an algorithm. In another example, the base cutter includes multiple blades, and the one or more vibration sensors includes a vibration sensor mounted to the base cutter corresponding to each of the multiple blades.

In another implementation of the present disclosure, a method of controlling a sugarcane harvester base cutter is provided. The method can include operating the base cutter to sever sugarcane plants from the ground and detecting, via one or more vibration sensors mounted to the base cutter, vibrations resulting from severing the sugarcane plants. The method also includes communicating, via the one or more vibration sensors, one or more vibration signals to a controller, assessing ratoon cut quality based on the one or more vibration signals, and adjusting one or more operating parameters of the base cutter.

In one example of this implementation, the one or more vibration signals includes one or more impacts each having a duration and amplitude corresponding to a blade severing a sugarcane plant from the ground. In a second example, the duration exceeding a duration threshold corresponds to a low ratoon cut quality. In a third example, the amplitude falling below an amplitude threshold corresponds to a low ratoon cut quality. In a fourth example, the method includes keeping track of impacts that indicate a low ratoon cut quality and adjusting the one or more operating parameters of the base cutter when the number of low-quality ratoon cuts exceeds a threshold. In a fifth example, the operating parameters include a knockdown roller height, a base cutter speed, a base cutter angle, or a harvester speed.

In another example, assessing the ratoon cut quality based on the one or more vibration signals includes using a model. In a further example, the model is a trained neural network. In yet another example, the model is an algorithm. In another example, the method includes communicating the one or more vibration signals to the controller wirelessly.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1A is a perspective view of a sugarcane harvester.

FIG. 1B is a side view of the sugarcane harvester of FIG. 1A.

FIG. 2 is a side view of a front portion of the sugarcane harvester.

FIG. 3 is a partial perspective view of the knockdown roller and base cutter assemblies.

FIG. 4 is a partial side view of the knockdown roller and base cutter assemblies.

FIG. 5 is a perspective view of the base cutter adjustment mechanism.

FIG. 6 is a perspective view of the base cutters.

FIG. 7 is a schematic representation of a control system.

FIG. 8 is a block diagram illustrating one implementation of monitoring ratoon cut quality and adjusting a sugarcane harvester base cutter.

FIG. 9 is a flow chart illustrating a method of controlling a sugarcane harvester base cutter.

FIG. 10 is a graph of representative vibration signals.

Corresponding reference numerals are used to indicate corresponding parts throughout the several views.

### DETAILED DESCRIPTION

Before any implementations of the disclosure are explained in detail, it is to be understood that the disclosure is not limited in its application to the details of construction and the arrangement of components set forth in the following description or illustrated in the accompanying drawings. The disclosure is capable of supporting other implementations and of being practiced or of being carried out in various ways. Also, it is to be understood that the phraseology and terminology used herein is for the purpose of description and should not be regarded as limiting.

Sugarcane production uses the ratooning method where the roots and a small portion of crop above the ground, called a “ratoon,” is left intact after harvesting. The ratoon is then allowed to regrow, and the crop is again harvested. Sugarcane growers typically repeat this cycle for 4 to 6 cycles. Therefore, maintaining a good cut quality becomes important for subsequent harvest and maintaining yield. A sugarcane harvester uses a base cutter to cut the crop near the bottom to maintain a uniform and good quality stubble which can grow again for the next harvest.

The present disclosure relates to a system for monitoring the ratoon cut quality using sound and/or vibration sensors and analysis. The system uses one or more sensors, such as accelerometers, microphones, and piezoelectric vibration sensors, placed near the harvester base cutter blades to detect sound and vibration during sugarcane cutting. An uneven or bad cut will be reflected as an anomalous signal. In some implementations, an anomaly detection model is trained to recognize these anomalies corresponding to uneven/bad cuts. In response, the base cutter speed and angle, machine forward speed, knockdown roller height and/or other machine parameters can be adjusted manually and/or automatically based on the detected cut quality. In some implementations, the signals captured using these sensors can be preprocessed to remove unwanted machine noises and vibrations, for example.

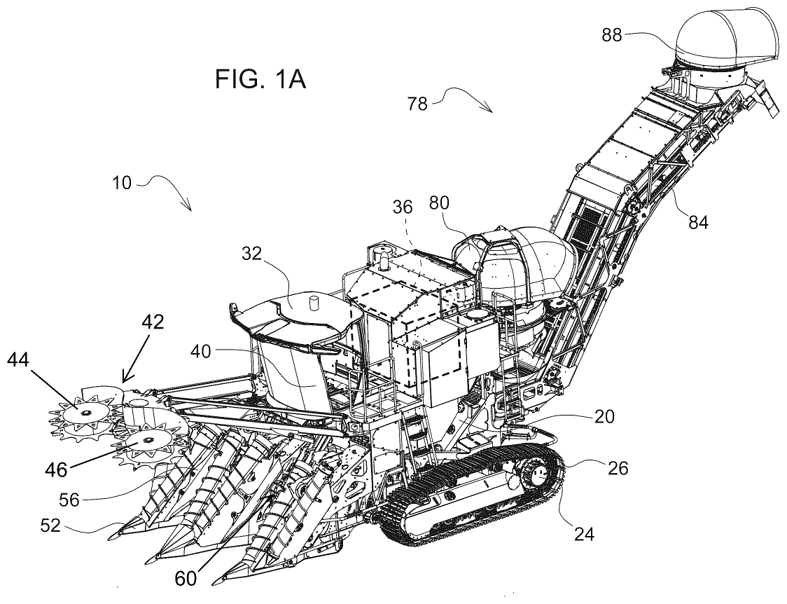

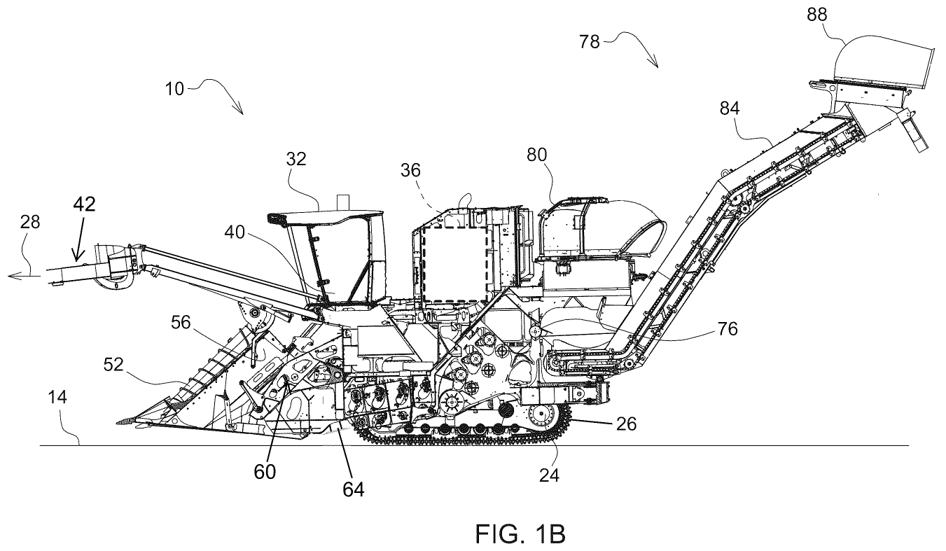

FIG. 1A illustrates a harvester 10, such as a sugarcane harvester, configured to harvest crop from a field 14. The illustrated harvester 10 includes a main frame 20 supported on one or more ground-engaging mechanisms such as wheels 24 or tracks 26 that engage the field 14 in order to move the harvester 10 across the field 14 in a direction of travel 28 (FIG. 1B). In some implementations, the wheels 24 may include continuous tracks 26 or other traction devices. An operator's cab 32 is mounted on the frame 20 adjacent a prime mover 36, such as an engine. The prime mover 36 may be an internal combustion engine or other such device for providing motive power. The harvester 10 includes a throttle control 40 (e.g., a lever, button, switch, pedal, etc.) for controlling a speed of the prime mover 36 and thus a speed of the harvester 10 (also referred to as the harvester speed). The harvester 10 includes a pair of crop lifters 52 mounted to the front of the frame 20, defining an inlet 56 for receiving the crop.

The harvester 10 also includes a topper 42 which cuts off the top portion of the sugarcane stalks, thereby removing the leaves and unwanted foliage before the main stalk is harvested by the rest of the harvester 10. The topper 42 cuts off the top portion of the sugarcane and discards it to the side of the harvesting row. The topper 42 typically includes rotating cutters 44 and 46 that can reach high enough to cut the tops of tall sugarcane plants. After cutting, the severed sugarcane tops are usually discharged to the side of the harvesting row.

FIG. 1B illustrates a side view of the harvester 10 with some portions removed to show the underlying components. The crop lifters 52 cooperate with knockdown roller assemblies 60 and base cutters 64 to remove the crop from the field 14. The harvester 10 further includes a chopper 76, and a cleaning arrangement or cleaning system 78 (also referred to as a residue discharge system) including a primary separator 80 and/or a secondary separator 88. The harvester 10 also includes a conveyor 84 (also referred to as an elevator) connecting the primary separator 80 and the secondary separator 88.

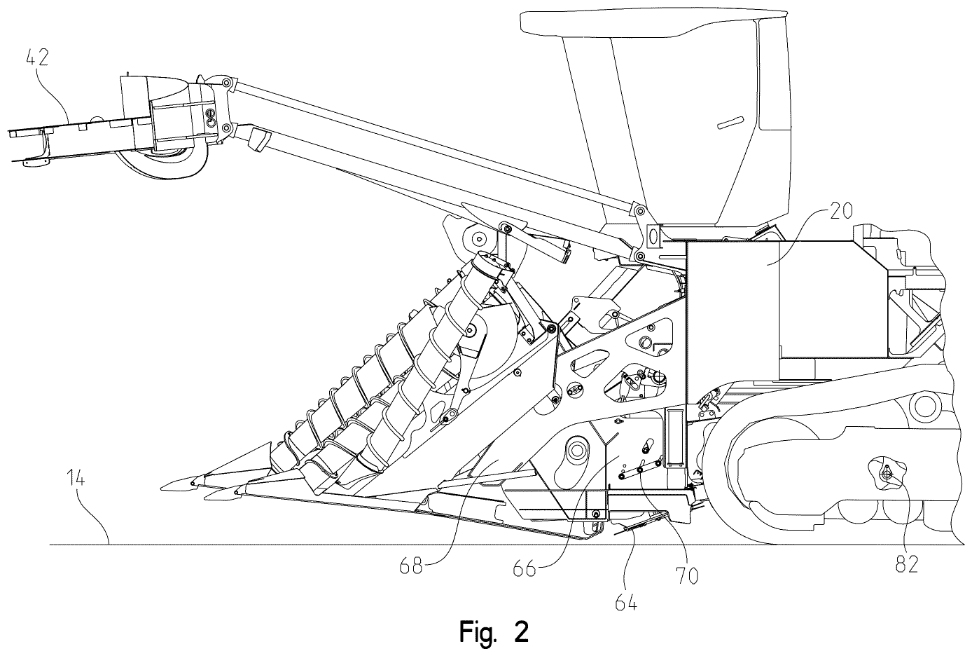

As shown in FIG. 2 the base cutters 64 are carried by a movable implement frame 66. The implement frame 66 can move with respect to cantilever frames 68 that are in turn mounted to the main frame 20. The base cutters 64 can also be manually adjusted with respect to the implement frame 66 via slots and fasteners 70, such as cooperating nuts and bolts. Accordingly, the angle of the base cutters 64 can be adjusted with respect to the field 14 by manual adjustment via the slots and fasteners 70 as well as by automated adjustment by pivoting the implement frame 66 about pivot joint 82.

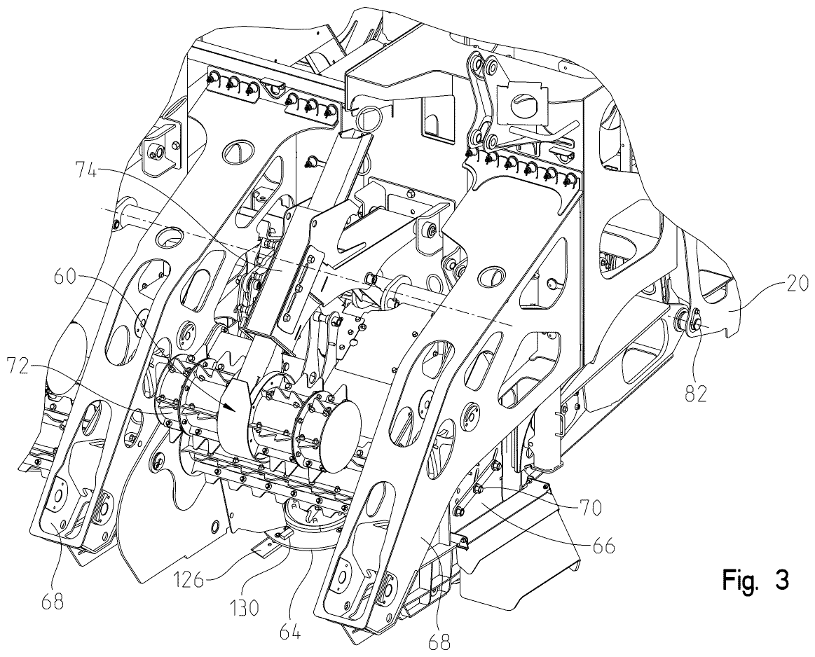

With further reference to FIG. 3, the implement frame 66 pivots with respect to the cantilever frames 68 and the main frame 20 about pivot joints 82 that are fixed on the main frame 20. The knockdown roller assemblies 60 are pivotably mounted to the mainframe 20 and are also connected to the implement frame 66. Each knockdown roller assembly 60 includes a manually adjustable frame assembly 74 that carries a knockdown roller 72. In addition to being manually adjustable, the knockdown roller assembly 60 moves up and down with the base cutters 64.

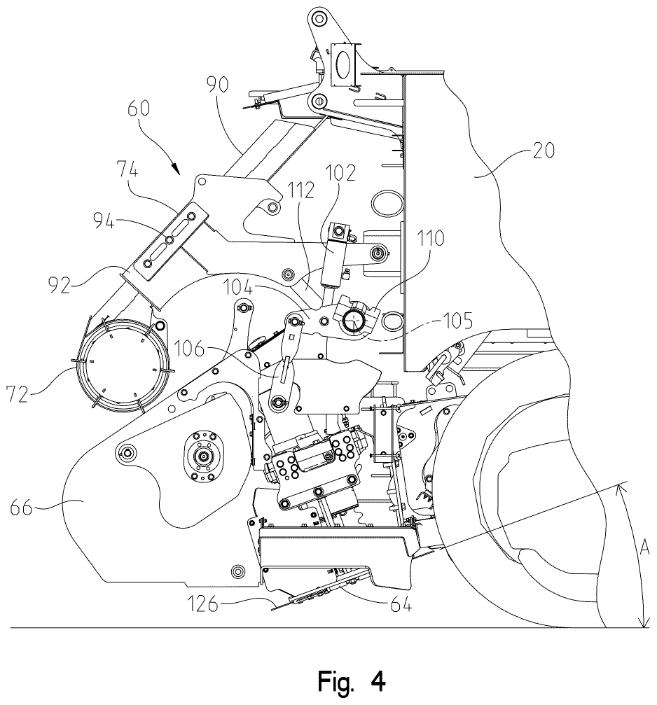

As shown in FIG. 4 the frame assembly 74 includes a pivot arm 92 and a telescoping member 90. The knockdown roller 72 is attached to the telescoping member 90 and is adjustable with respect to pivot arm 92. The telescoping member 90 is held in position within a tube portion of the pivot arm 92 with a plurality of suitable fasteners such as screws 94. The height of the knockdown roller 72 can therefore be adjusted up and down manually by loosening screws 94 and telescoping the telescoping member 90 in or out of the pivot arm tube and then retightening the screws 94.

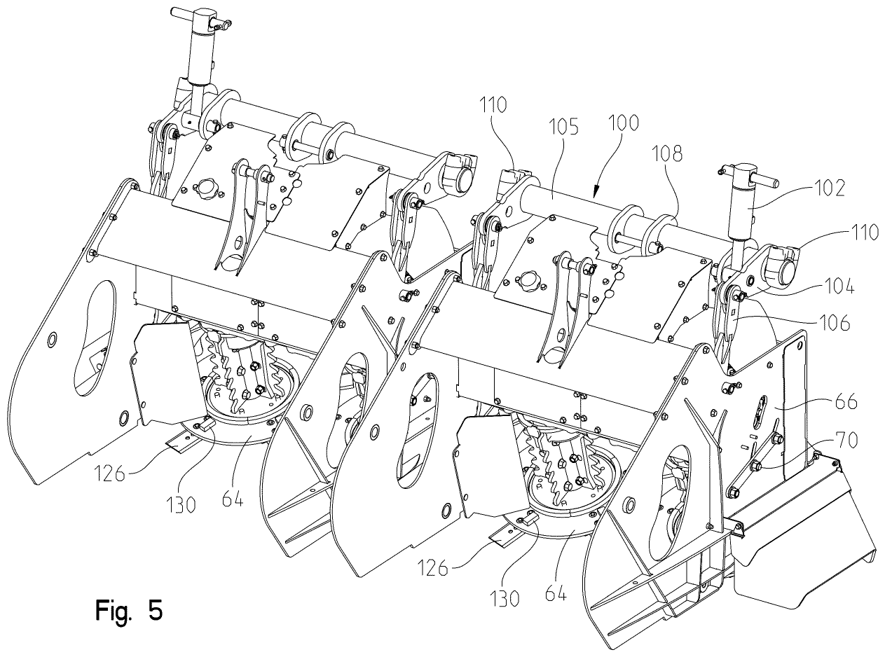

With continued reference to FIG. 4, the height and angle A of the base cutters 64 can be adjusted with actuators 102. Each actuator 102 pulls/pushes up and down on a lever arm 104 which in turn moves a drop link 106 connected to the base cutter assembly 64 via implement frame 66. The lever arms 104 are connected to a torsion tube 105 that pivots in bearing blocks 110. The height of the knockdown roller 72 can also be adjusted by the actuator 102 by a connector link 112 which also attaches to a clevis 108 (FIG. 5) on the torsion tube 105. The bearing blocks 110 are mounted to the cantilever frame 68.

FIG. 5 is a perspective view illustrating an example of an implement adjustment mechanism 100. The implement adjustment mechanism 100 can simultaneously adjust the base cutters 64 and the knockdown rollers 72. The implement adjustment mechanism 100 includes the torsion tube 105 with a pair of the lever arms 104 attached (e.g., welded) thereto. The torsion tube 105 rotates in bearing blocks 110 which are mounted to the cantilever frames 68. In one implementation, a linear actuator 102 is coupled at a first end to the cantilever frame 68 (FIG. 3) and coupled to the lever arm 104 at a second end. In some implementations, the actuator 102 can be a linear actuator, a hydraulic actuator, an electric actuator, a mechanical actuator, a hydro-mechanical actuator, a rotary actuator, an electro-mechanical actuator, or any other known type of actuator. The linear actuator 102 moves between an extended position and a retracted position to adjust the height and angle of the implement frame 66.

The clevis 108 is also attached to the torsion tube 105 which is in turn connected to the knockdown roller frame assembly 74 via connector link 112 (FIG. 4). The drop links 106 are connected between a distal end of the lever arm 104 and the implement frame 66. When actuator 102 is extended (downward) it causes the torsion tube 105 to rotate counterclockwise pushing the lever arms 104 and drop links 106 downwards thereby lowering the base cutter 64 as well as increasing the angle A of the base cutter 64 with respect to the field 14. At the same time, the clevis 108 rotates counterclockwise thereby moving the knockdown roller assembly 60 downward. When actuator 102 is retracted (upward) it causes the torsion tube 105 to rotate clockwise raising the lever arms 104 and drop links 106 upwards thereby raising the base cutter 64 as well as decreasing the angle A of the base cutter 64 with respect to the field 14. At the same time, the clevis 108 rotates clockwise thereby moving the knockdown roller assembly 60 upward.

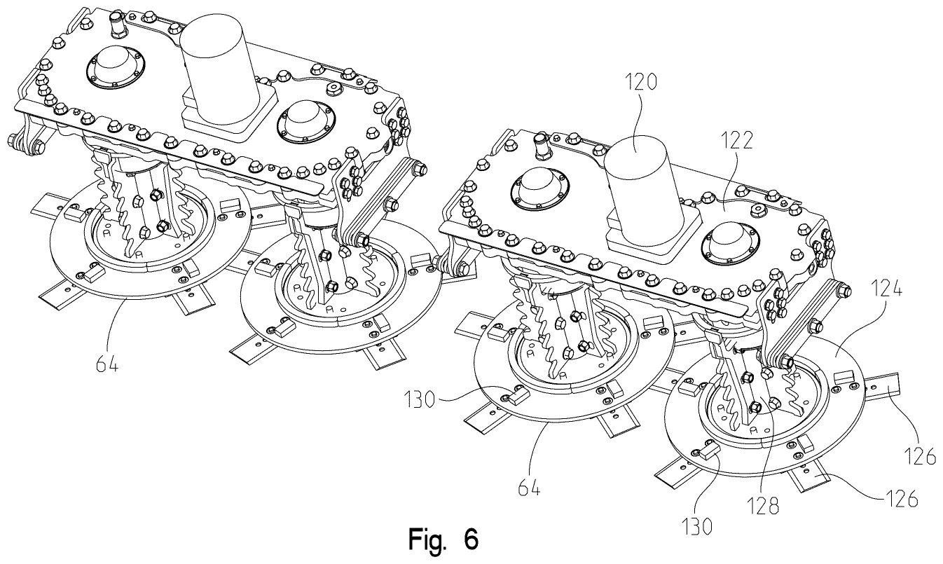

FIG. 6 is a perspective view of the base cutter assemblies 64. Each base cutter assembly 64 includes a rotary actuator such as a hydraulic motor 120. The hydraulic motor 120 is mounted to a gearbox 122 which transfers torque from the hydraulic motor 120 via a gear set (not shown) to cutter shafts 128. Each cutter shaft 128 connects to a blade carrier 124 having multiple blades 126 mounted about its circumference. In some implementations, a sensor 130(1)-130(n) is mounted on the carrier 124 adjacent each of the blades 126. Each sensor 130(1)-130(n) generates a vibration signal indicative of a ratoon cut quality. Thus, each sensor provides a signal by which the controller 300 can monitor the ratoon cut quality resulting from each blade 126. Although each blade 126 is shown with its own sensor 130(1)-130(n) in the depicted implementation, in other implementations more or fewer sensors 130 can be used. For example, in some implementations a single sensor 130 can monitor a single blade carrier 124 and all of its associated blades 126. Thus, a single sensor 130 would generate a signal for each of the blades 126.

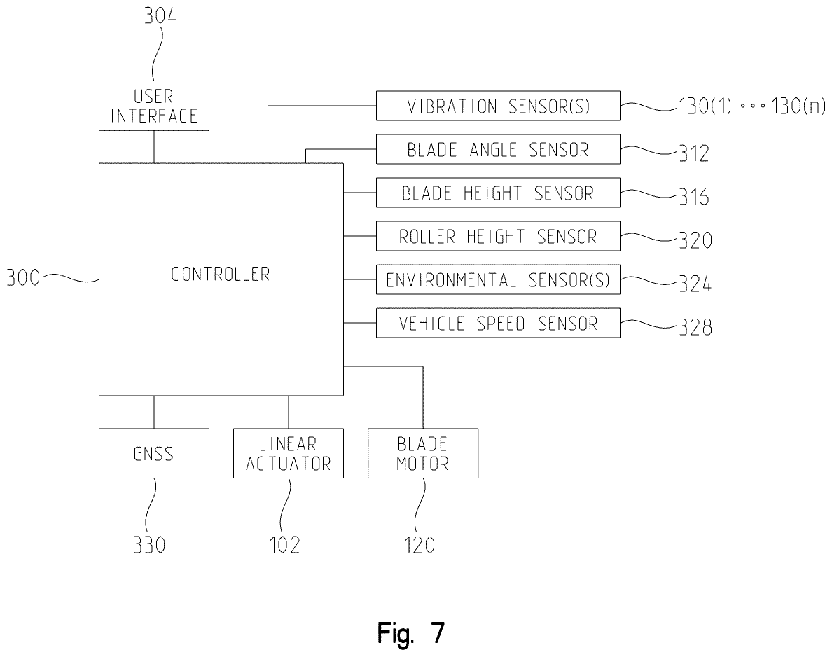

The vibration sensors 130(1)-130(n) can be accelerometers, microphones, and/or piezoelectric vibration sensors, for example. The vibration sensors 130(1)-130(n) may be coupled to the blade carrier 124 in any known manner (e.g., mechanical fastener, adhesive, welding, integrally coupled, etc.). Although not shown in FIG. 6, the plurality of sensors 130(1)-130(n) may be in communication with a control system including a controller 300 (FIG. 7) which receives outputs from each of the plurality of sensors 130(1)-130(n). The vibration sensors 130(1)-130(n) may be coupled to a power source. In one implementation, the power source may be a battery, such as, for example, a battery housed in the sensor or a hardwired connection to a battery of the harvester 10. In another implementation, the power source may be piezoelectric energy harvesting, thermoelectric energy harvesting, solar power, wind power, or any other method of generating power to a sensor known in the art. In one implementation, the controller 300 may be wirelessly coupled to the vibration sensors 130(1)-130(n). In another implementation, the controller 300 may be hardwired to the vibration sensors 130(1)-130(n) via a slip ring connector for example.

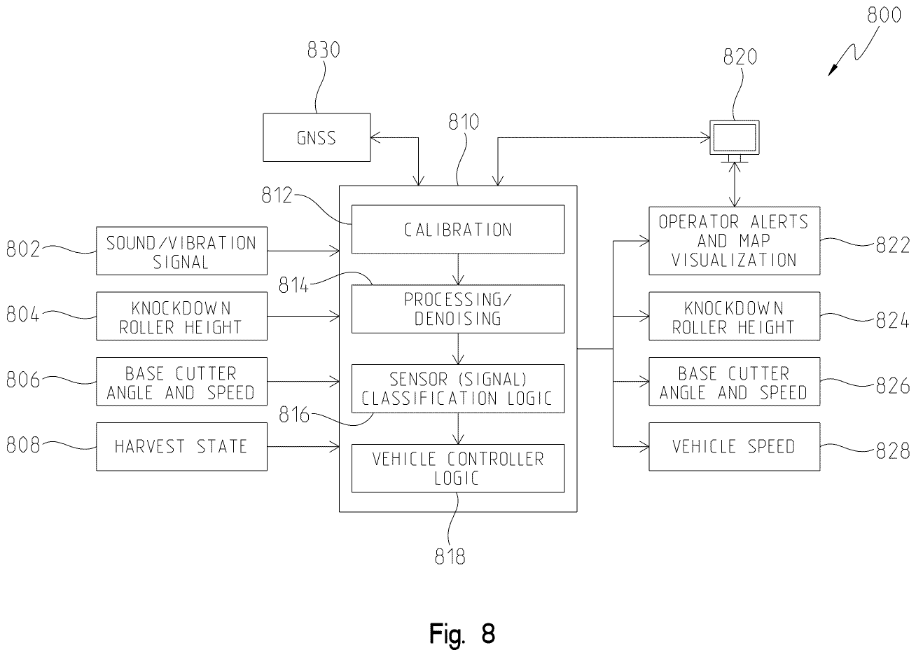

FIG. 7 illustrates a schematic representation of a control system having a controller 300, a user interface 304, and a plurality of sensors 130(1)-130(n), 312, 316, 320, 324, and 328. The controller may be located within the harvester 10 and may be incorporated into an electronic control unit (ECU) of the harvester 10, may be electronically coupleable to the ECU, or may be a separate system operable independent of the ECU. The controller 300 may automatically modify one or more of the knockdown roller height, the base cutter speed, the base cutter angle, and/or a harvester speed based on various inputs from the user interface 304 and signals received from the sensors 130(1)-130(n), 312, 316, 320, 324, and 328. Representative control schemes are described with respect to FIGS. 8-10, for example. With continued reference to FIG. 7, the user interface 304 may be a console located within the operator's cab 32 having one or more inputs such as a touch screen, switches, dials, and buttons that can be actuated by a user/operator for modifying operation of the harvester 10. The user interface 304 is electrically coupled to the controller 300 such that inputs provided by the user to the user interface 304 are transmitted to the controller 300. Additionally, the controller 300 is operable to provide signals that generate outputs at the user interface 304 indicating information (e.g., vehicle status, vehicle performance) calculated, stored in, or otherwise transmitted by the controller 300. In other implementations, changing the knockdown roller height, the base cutter speed, the base cutter angle, and/or a harvester speed may be manually adjustable (via inputs in the cab and/or manually at the knockdown roller and/or base cutter).

The vibration sensors 130(1)-130(n) can be placed near the harvester base cutter blades 126 (e.g., FIG. 6) to detect sound and vibration during sugarcane cutting. The vibration sensors 130(1)-130(n) can be accelerometers, microphones, and/or piezoelectric vibration sensors, for example. In some implementations, a base cutter angle sensor 312 measures the angle of the blades 126 with respect to the ground 14 and a base cutter height sensor 316 measures the height of the blades 126 from the ground 14. A knockdown roller height sensor 320 measures the height of the knockdown roller 72 with respect to the ground 14. In some implementations, the angle and height of the blades 126 and the height of the knockdown roller 72 can be adjusted manually and/or with associated actuators. In an example implementation, the angle and height of the blades 126 and the height of the knockdown roller 72 are adjusted to some extent with a linear actuator 102. They may also be adjusted manually as explained above.

One or more environmental sensors 324 may be located on or at a periphery of the harvester 10 to determine different ambient conditions such as temperature, humidity, field conditions such as soil saturation level, plant density, geographical data, and ground angle/gradient. The environmental sensor(s) 324 may additionally provide some characteristics (e.g., density, weight, height) of the harvested plant. A vehicle speed sensor 328 measures the velocity of the harvester 10. The controller 300 receives signals from the vehicle speed sensor 328 that aids in determining a volumetric throughput of material through the harvester 10. In some implementations, the controller 300 may also receive information from a Global Navigation Satellite System (GNSS) 330, such as global positioning, navigation, and timing information.

The controller is further programmed to provide signals to one or more actuators such as the linear actuator 102 and to the blade motors 120 to modify operational parameters (e.g., knockdown roller height, base cutter speed, base cutter angle, and/or a harvester speed) in response to the signals provided by the sensors 130(1)-130(n), 312, 316, 320, 324, and 328.

FIG. 8 is a block diagram illustrating one implementation of a system 800 for monitoring ratoon cut quality and adjusting parameters for a sugarcane harvester including base cutter and knockdown roller parameters. In some implementations, the system 800 can include a control algorithm 810 that receives signals from various sensors (e.g., sensors 130(1)-130(n), 312, 316, 320, 324, and 328). For example, the algorithm 810 can receive sound and/or vibration information/signals 802 from the vibration sensors 130. The control algorithm 810 can also receive roller height information/signals 804 from the knockdown roller height sensor 320 and base cutter angle and speed information/signals 806 from the base cutter angle and height sensors 312 and 316, respectively. The control algorithm 810 can also receive harvest state information 808 which can be determined or estimated based on sensor information such as temperature, humidity, etc. from the environmental sensor(s) 324.

The control algorithm 810 can include a calibration module 812, a preprocessing and denoising module 814, a sensor classification logic module 816, and a vehicle controller logic module 818. The calibration module 812 can include information related to the sensors, e.g., vibration sensors 130(1)-130(n), for calibrating the sensors. The preprocessing and denoising module 814 can account for noise and vibration caused by the harvester itself which is unrelated to the severing of sugarcane plants from the ground. Prior to harvesting, the system can record inherent noise and vibration from the machine which is subsequently removed from the vibration signals during harvesting operations. Once the sensors are calibrated, preprocessed, and denoised vibration signals 802 from the vibration sensors 130(1)-130(n) can be fed to the classification logic module 816 for classification.

The classification logic module 816 can use a model to provide a classification of the ratoon cuts using the signals from the vibration sensors 130(1)-130(n) as well as the harvester parameters as measured by sensors 312, 316, 320, 324, and 328. The model can be an algorithm or a trained machine learning model, such as logistic regression, naive bayes, decision trees, support vector machines (SVM), random forest, neural networks, and K-nearest neighbors, for example. In some implementations, a machine learning model can provide a binary classification. For example, the ratoon cuts can be classified as acceptable or unacceptable. In other implementations, the model can provide a multi-class classification. For example, the ratoon cuts can be classified by defect, such as incomplete cut, dull blade, partially damaged, severely damaged, and undamaged, for example.

Prior to deployment, the model can be exposed to training data, where it adjusts its internal parameters to minimize the difference between its ratoon cut quality predictions/classifications and the actual known outcomes labeled in the training data (e.g., supervised learning). Other learning models can be utilized for the purpose of learning, classification, and prediction.

The vehicle control logic module 818 acts on the classification provided by the classification logic module 816 to direct changes or adjustments to the harvester parameters. In other words, the vehicle controller logic 818 executes a response strategy based on the ratoon cut quality assessment. For example, the vehicle controller logic 818 can provide operator alerts and map visualizations 822 via a user interface 820. In some implementations, the control algorithm 810 can communicate with a GNSS 830 in order to log and/or map the ratoon cut quality classifications relative to geographical position in the field 14.

The vehicle controller logic module 818 can also adjust or change one or more of the knockdown roller height, the base cutter speed, the base cutter angle, and/or a harvester speed to account for unfavorable ratoon cut classifications. In some implementations, the control algorithm 810 can send instructions 824, 826, and 828 to control the knockdown roller height, base cutter angle and speed, and vehicle speed, respectively. For example, the control logic 818 can send instructions to reduce vehicle speed, decrease base cutter angle, increase base cutter speed, and/or raise the knockdown roller height in response to a negative classification.

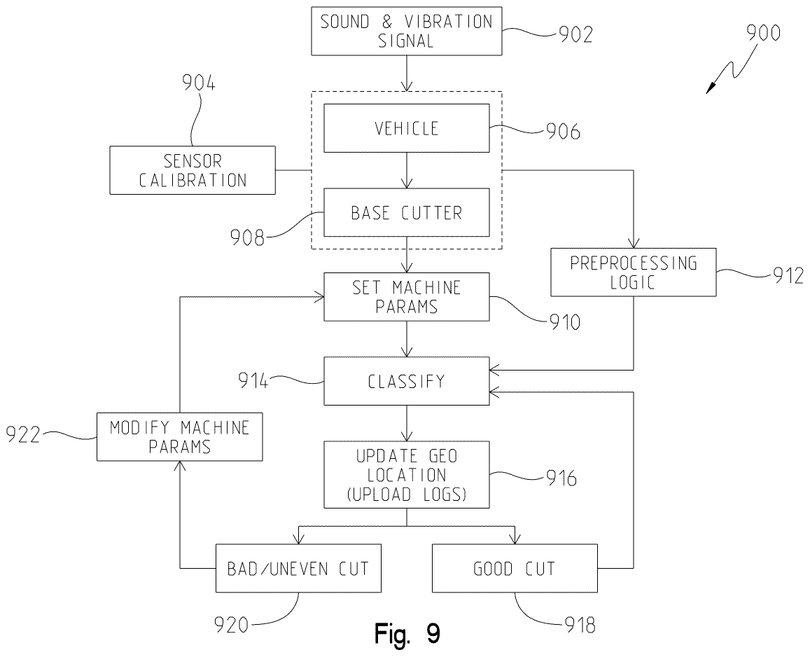

FIG. 9 illustrates one implementation of a method 900 for controlling a sugarcane harvester base cutter. The method 900 may include a set of instructions or blocks that are executable by a controller 300 or operator of a harvester. The controller 300 may be located on the harvester or remote therefrom. The controller may include a memory unit and a processor unit. The memory unit may be capable of storing algorithms, models, processes, programs, software, look up tables, data, charts, diagrams, etc. In some implementations, the method 900 may include additional or fewer blocks. In another implementation, the blocks may be executed in a different order.

The method 900 begins at block 902 where a controller 300 receives one or more vibration signals from one or more vibration sensors 130. The one or more vibration signals are indicative of impacts associated with the base cutter blades 126 severing sugarcane from the field 14.

Following block 902, the method advances to block 904 where the controller 300 calibrates the sensors 130. The calibration can adjust for vehicle noise 906 and base cutter noise 908, for example. During calibration 904, in block 906 the controller 300 can receive and record vibration signals from the sensors 130 when only the vehicle (e.g., prime mover 36) is running. Similarly, in block 908, the controller 300 can receive and record vibration signals from the sensors 130 when only the base cutters 64 are running. These signals can be subtracted from the vibration signals received during harvesting operations to help isolate vibrations associated with sugarcane impacting the blades 126. In some implementations, the calibration steps only need to occur at the beginning of harvesting operations and the sensor calibration block 904 can be bypassed during harvesting. After block 904, the method proceeds to blocks 910 and 912.

In block 910, the controller 300 sets the machine parameters. At the beginning of harvesting operations, the controller 300 can initialize the machine parameters with default or last used values, for example. During harvesting operations, the controller 300 can make adjustments to the machine parameters based on the signals from the vibration sensors 130. These adjustments are fed to block 910 to adjust the machine and/or instruct the operator to make adjustments. In some implementations, the controller can adjust the height and angle A of the base cutter 64 by activating the actuator 102 as explained above. The height of the knockdown roller 72 can also be adjusted by the actuator 102. In some implementations, the adjustments are automatically performed by the controller 300. In other implementations, the adjustments can be semi-automatic in that the controller 300 can indicate to an operator, e.g., via the interface 304/820, that certain parameters, e.g., blade angle, could be adjusted to improve ratoon cut quality and allow the operator to authorize or ignore the suggested changes. In still other implementations, the controller 300 can indicate to the operator the certain adjustments could be beneficial to the ratoon cut quality and allow the operator to set the parameters that are then changed by the controller and/or allow for manual adjustments to the machine by the operator. For example, the knockdown roller height relative to the base cutter can be adjusted by moving the telescoping member 90 with respect to pivot arm 92, as explained above.

In block 912, the controller 300 preprocesses the incoming vibration signals to isolate vibrations associated with sugarcane impacting the blades 126 from baseline vibrations from the harvester and base cutter. After blocks 910 and 912, the method proceeds to block 914.

In block 914, the controller 300 assesses/classifies ratoon cut quality based on the one or more vibration signals received in block 902 and preprocessed in block 912. The one or more vibration signals includes one or more impacts each having a duration and amplitude corresponding to a blade severing a sugarcane plant from the ground. The controller 300 is configured to assess/classify the one or more vibration signals with a model. In some implementations the model can be a trained neural network and in others it can be an algorithm.

In some implementations, when the duration exceeds a duration threshold Tₜ, the ratoon cut quality is deemed to correspond to a low ratoon cut quality. In some implementations, when the amplitude falls below an amplitude threshold T_{A} the ratoon cut quality is deemed to correspond to a low ratoon cut quality. Conversely, the ratoon cut quality is deemed to be acceptable when the duration is within the duration threshold Tₜ and the amplitude exceeds the amplitude threshold T_{A}. In some implementations, the controller 300 is configured to keep track of impacts that indicate a low ratoon cut quality and execute a response strategy when the number of low-quality ratoon cuts exceeds a threshold Tₙ. After block 912, the method proceeds to block 916.

In block 916, the controller 300 can record ratoon cut quality data (e.g., good or bad) relative to the harvester's location in the field. The system can receive GNSS location information to set the harvester's location in the field. The cut quality data can be displayed in a map, for example, which is presented on the user interface 304/820. After block 916, the method proceeds to one of blocks 918 or 920.

In blocks 918/920, the controller 300 determines whether the ratoon cut quality is good or bad/uneven. If the ratoon cut quality is good (block 918) the method returns to block 914 where the system continues to monitor the ratoon cut quality. If the ratoon cut quality is bad/uneven (block 920) the method proceeds to block 922.

In block 922, the controller 300 can execute a response strategy including changing and/or recommending changing parameters corresponding to one or more of the knockdown roller height, the base cutter speed, the base cutter angle, or a harvester speed. After block 922, the method returns to block 910 where the system adjusts the machine parameters according to the modified machine parameters from block 922.

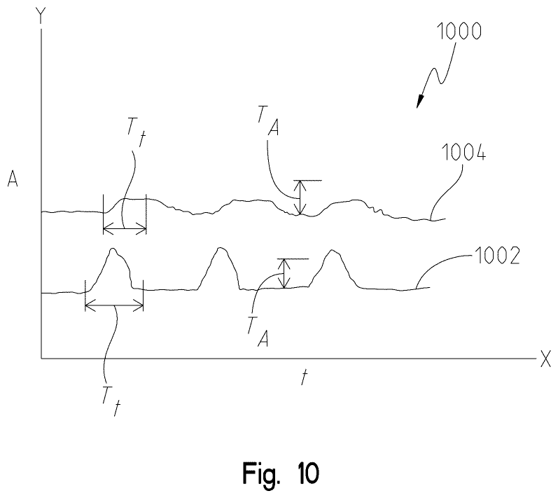

FIG. 10 is a graph 1000 illustrating two representative vibration sensor signals 1002 and 1004 each corresponding to a sensor located adjacent a blade 126. The X-axis represents time (t), and the Y-axis represents amplitude (A) (e.g., voltage) of the signals. The vibration signal 1002 represents a series of impacts corresponding to good/clean cuts and the vibration signal 1004 represents a series of impacts corresponding to bad/uneven cuts. Each spike on the signals 1002 and 1004 represents an impact associated with severing a stalk of sugarcane. In one implementation, a signal can be determined to represent a bad cut based on a time threshold Tₜ and/or an amplitude threshold T_{A}. Each spike in the signal 1002 has a duration that is within the time/duration threshold Tₜ and exceeds the amplitude threshold T_{A}. In contrast, the bad/uneven signal 1004 includes spikes that exceed the time threshold Tₜ and falls below the amplitude threshold T_{A}. In some implementations, other known signal processing algorithms may be used to evaluate the vibration signals to determine ratoon cut quality.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

What is claimed is:

1. A sugarcane harvester, comprising:
a knockdown roller having an adjustable height;
a base cutter positioned to sever sugarcane plants from the ground, the base cutter having an adjustable speed and angle;
one or more vibration sensors mounted to the base cutter to detect vibration resulting from severing the sugarcane plants and configured to generate one or more vibration signals; and
a controller in communication with the one or more vibration sensors, the controller configured to:
receive the one or more vibration signals;
assess ratoon cut quality based on the one or more vibration signals; and
execute a corresponding response strategy.

2. The sugarcane harvester of claim 1, wherein the one or more vibration signals includes one or more impacts each having a duration and amplitude corresponding to a blade severing a sugarcane plant from the ground.

3. The sugarcane harvester of claim 2, wherein the duration exceeding a duration threshold corresponds to a low ratoon cut quality.

4. The sugarcane harvester of claim 2, wherein the amplitude falling below an amplitude threshold corresponds to a low ratoon cut quality.

5. The sugarcane harvester of claim 2, wherein the controller is configured to keep track of impacts that indicate a low ratoon cut quality and execute the response strategy when the number of low-quality ratoon cuts exceeds a threshold.

6. The sugarcane harvester of claim 5, wherein the response strategy includes changing one or more of the knockdown roller height, the base cutter speed, the base cutter angle, or a harvester speed.

7. The sugarcane harvester of claim 1, wherein the controller is configured to assess the one or more vibration signals with a model.

8. The sugarcane harvester of claim 7, wherein the model is a trained neural network.

9. The sugarcane harvester of claim 7, wherein the model is an algorithm.

10. The sugarcane harvester of claim 1, wherein the base cutter includes multiple blades, and the one or more vibration sensors includes a vibration sensor mounted to the base cutter corresponding to each of the multiple blades.

11. A method of controlling a sugarcane harvester base cutter, the method comprising:
operating the base cutter to sever sugarcane plants from the ground;
detecting, via one or more vibration sensors mounted to the base cutter, vibrations resulting from severing the sugarcane plants;
communicating, via the one or more vibration sensors, one or more vibration signals to a controller;
assessing ratoon cut quality based on the one or more vibration signals; and
adjusting one or more operating parameters of the base cutter.

12. The method of claim 11, wherein the one or more vibration signals includes one or more impacts each having a duration and amplitude corresponding to a blade severing a sugarcane plant from the ground.

13. The method of claim 12, wherein the duration exceeding a duration threshold corresponds to a low ratoon cut quality.

14. The method of claim 12, wherein the amplitude falling below an amplitude threshold corresponds to a low ratoon cut quality.

15. The method of claim 12, further comprising keeping track of impacts that indicate a low ratoon cut quality and adjusting the one or more operating parameters of the base cutter when the number of low-quality ratoon cuts exceeds a threshold.

16. The method of claim 11, wherein the operating parameters include a knockdown roller height, a base cutter speed, a base cutter angle, or a harvester speed.

17. The method of claim 11, wherein assessing the ratoon cut quality based on the one or more vibration signals includes using a model.

18. The method of claim 17, wherein the model is a trained neural network.

19. The method of claim 17, wherein the model is an algorithm.

20. The method of claim 11, further comprising communicating the one or more vibration signals to the controller wirelessly.
